(19) United States
(12) Patent Application Publication
(10) Pub. No.: US 2017/0171598 A1
(43) Pub. Date: Jun. 15, 2017

(54) BROADCAST RECEIVING APPARATUS AND CONTROLLING METHOD THEREOF

(71) Applicant: Samsung Electronics Co., Ltd., Suwon-si (KR)

(72) Inventor: Jae-young PARK, Suwon-si (KR)

(73) Assignee: Samsung Electronics Co., Ltd., Suwon-si (KR)

(21) Appl. No.: 15/372,805

(22) Filed: Dec. 8, 2016

(30) Foreign Application Priority Data
Dec. 10, 2015 (KR) 10-2015-0176034

(51) Int. Cl. H04N 21/43; H04N 21/8547; H04N 21/854; H04N 21/434

(52) U.S. Cl. CPC H04N 21/4305; H04N 21/4343; H04N 21/8547; H04N 21/4342; H04N 21/854

(57) ABSTRACT

Provided herein is a controlling method of a broadcast receiving apparatus, the controlling method including receiving a Transport Stream (TS) packet from an external source; extracting a Program Clock Reference (PCR) and a time stamp from the TS packet; computing a difference value between the PCR value and the time stamp value; generating a system timing clock based on the computed difference value and a buffering time during which the broadcast receiving apparatus decodes an Elementary Stream (ES) packet included in the TS packet; and decoding the ES packet based on the generated system timing clock.

### CROSS-REFERENCE TO RELATED APPLICATIONS

This application claims priority from Korean Patent Application No. 10-2015-0176034, filed on Dec. 10, 2015, in the Korean Intellectual Property Office, the disclosure of which is incorporated herein by reference in its entirety.

### BACKGROUND

1. Field

Apparatuses and methods consistent with the present disclosure relate to a broadcast receiving apparatus and a controlling method thereof, and more particularly, to a broadcast receiving apparatus configured to decode a Moving Picture Experts Group (MPEG) transport stream, and a controlling method thereof.

2. Description of the Related Art

Along with digitalization, the image compression technology is a core element that supports multimedia. Recently, digitalization of information is developing at a rapid pace, and thus, the importance of the image compression technology is being emphasized.

The Moving Picture Expert Group (MPEG) is an international standard for compressed coding of digital video which is a core technology in an multimedia environment.

Especially, in order to adjust the broadcasting station that encodes and transmits AV contents and the decoding speed of the broadcast receiving apparatus that receives and decodes the AV contents to be identical to each other, the MPEG 2 system spec regularly transmits a Program Clock Reference (PCR) value. In the audio and video data being transmitted according to the MPEG 2 system spec, a Presentation Time Stamp (PTS) value that displays the replay time is allocated, and the broadcast receiving apparatus decodes the audio and video data with reference to the internal clock counter value generated based on the PCR value.

FIG. 1 is an exemplary view illustrating a Transport Stream (TS) packet processing process in a decoding end of a conventional MPEG 2 system.

As illustrated in FIG. 1, when the Transport Stream (TS) is received, the depacketizer 110 depacketizes the received TS into a Packetized Elementary Stream (PES), and provides the same to a PES depacketizer 120. In this process, the TS depacketizer 110 extracts the PCR from a TS packet header, and provides the extracted PCR to a PCR counter 150. Accordingly, the PCR counter 150 generates a system timing block, that is a reference clock of the decoding end, based on the received PCR, and provides the same to a comparer 160.

The PES depacketizer 120 that received the PES depacketizes the received PES into an Elementary Stream (ES), and the depacketized Elementary Stream (ES) is buffered to an ES buffer 130. Here, the PES depacketizer 120 provides to the comparer 160 a Decoding Time Stamp (DTS) or a Presentation Time Stamp (PTS) extracted in the depacketizing process.

Accordingly, the ES decoder 140 checks the comparer 150, and when the time corresponding to the DTS or PTS arrives with reference to the system timing clock provided by the PCR counter 150, the ES buffered in the ES buffer 130 is decoded.

As such, using the PCR, the MPEG 2 system can synchronize the clock of an encoding end and a decoding end, and thus synchronize the video and audio of a content and replay the same.

Meanwhile, according to the MPEG 2 system, a DTS value or Presentation Time Stamp (PTS) value is greater than the PCR value. This is because the reference time of the decoder must be generated first through the PCR in order to check whether or not the time corresponding to the DTS value arrived.

Here, the difference value between the PCR value and the PTS value becomes the buffering time required by the decoder. However, since the difference value between the PCR value and the PTS value that determines the buffering time of the decoder is set differently for each broadcast, each broadcast will have a different buffering time that is suitable for the decoder to actually use in processing the TS stream.

Therefore, in the case where the buffering time that a broadcast requires in a decoder is shorter than the actual buffering time used by the decoder, the decoder will operate erroneously. On the contrary, if the buffering time that a broadcast requires in the decoder is longer than the actual buffering time used by the decoder, a problem will occur where although the data to be decoded is already buffered after a channel conversion, decoding has to wait until an internal clock counter value of the broadcast receiving apparatus that operates based on the PCR reaches the PTS value, thereby deteriorating the channel conversion speed.

### SUMMARY

Additional aspects and/or advantages will be set forth in part in the description which follows and, in part, will be apparent from the description, or may be learned by practice of the embodiments.

A purpose of the present disclosure is to resolve the aforementioned problems of prior art, that is, to provide a broadcast receiving apparatus that is capable of improving the problems of erroneous operation and degradation of channel conversion speed, caused by the buffering time requested to the broadcast receiving apparatus according to the difference between the PCR and the time stamp being different from the actual buffering time used by the broadcast receiving apparatus to process a TS stream, and a controlling method thereof.

According to an embodiment of the present disclosure, provided herein is a method of controlling a broadcast receiving apparatus, the method including receiving a TS packet from an external source; extracting a PCR and a time stamp from the TS packet; computing a difference value between the PCR value and the time stamp value; generating a system timing clock based on the computed difference value and a buffering time during which the broadcast receiving apparatus decodes an ES packet included in the TS packet; and decoding the ES packet based on the generated system timing clock.

The generating a system timing clock may include computing an offset value that is a difference between the computed difference value and the buffering time; adjusting the PCR value using the computed offset value; and generating the system timing clock according to the adjusted PCR value.

The adjusting the PCR value may add the offset value to the PCR value if the difference value is greater than the buffering time.

The adjusting the PCR may subtract the offset value from the PCR value if the difference value is smaller than the buffering time.

The decoding may include checking whether or not a time corresponding to the time stamp value arrived with reference to the system timing clock; and decoding the ES packet according to the checking results.

The broadcast receiving apparatus may be a broadcast receiving apparatus that conforms to the MPEG 2 system spec (ISO/IEC 13818-1).

The time stamp may be at least one of a decoding time stamp (DTS) and a presentation time stamp (PTS).

According to another embodiment of the present disclosure, provided herein is a broadcast receiving apparatus including a receiver that receives a TS packet from an external source; a demultiplexer that demultiplexes the TS packet into a PES packet and an ES packet; a decoder that decodes the ES packet; and a processor that uses a PCR and a time stamp being extracted during the demultiplexing process of the demultiplexer to compute a difference value between the PCR value and the time stamp value, that generates a system timing clock based on a buffering time during which the broadcast receiving apparatus decodes the ES packet, and that controls the decoder to decode the ES packet based on the generated system timing clock.

The processor may compute an offset value that is a difference between the computed difference value and the buffering time, adjusts the PCR value using the computed offset value, and generates the system timing clock according to the adjusted PCR value.

The processor may add the offset value to the PCR value if the difference value is greater than the buffering time.

The processor may subtract the offset value from the PCR value if the difference value is smaller than the buffering time.

The processor may check whether or not a time corresponding to the time stamp value arrived with reference to the system timing clock, and control the decoder to decode the ES packet according to the checking results.

The broadcast receiving apparatus may be a broadcast receiving apparatus that conforms to the MPEG 2 system spec (ISO/IEC 13818-1).

The time stamp may be at least one of a decoding time stamp (DTS) and a presentation time stamp (PTS).

According to another embodiment of the present disclosure, provided herein is a computer readable record medium including a program for executing a controlling method of a broadcast receiving apparatus, the controlling method including receiving a TS packet from an external source; extracting a PCR and a time stamp from the TS packet; computing a difference value between the PCR value and the time stamp value; generating a system timing clock based on the computed difference value and a buffering time during which the broadcast receiving apparatus decodes an ES packet included in the TS packet; and decoding the ES packet based on the generated system timing clock.

According to the aforementioned various embodiments of the present disclosure, it is possible to improve the problems of erroneous operation in decoding and degradation of channel conversion speed that may occur due to the buffering time required in the broadcast receiving apparatus according to the difference between the PCR and the time stamp being different from the actual buffering time used by the broadcast receiving apparatus to process a TS stream, and a controlling method thereof.

### BRIEF DESCRIPTION OF THE DRAWINGS

The above and/or other aspects of the embodiments will be more apparent by describing certain embodiments of the present disclosure with reference to the accompanying drawings, in which:

FIG. 1 is an exemplary view illustrating a process of processing a TS packet of a conventional MPEG 2 system;

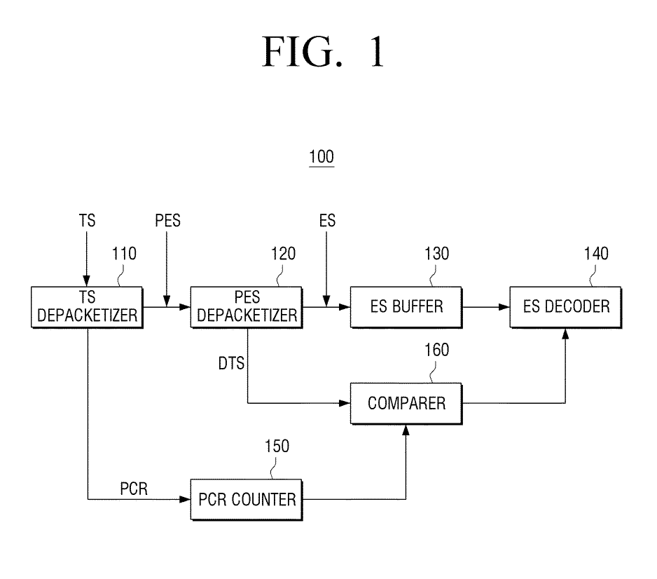

FIG. 2 is a block diagram illustrating a configuration of a broadcast receiving apparatus according to an embodiment of the present disclosure;

FIG. 3 is a block diagram illustrating in detail a configuration of a broadcast receiving apparatus according to another embodiment of the present disclosure;

FIG. 4 is a flowchart illustrating a controlling method of a broadcast receiving apparatus according to an embodiment of the present disclosure; and

FIG. 5 is a flowchart illustrating a controlling method of a broadcast receiving apparatus according to another embodiment of the present disclosure.

### DETAILED DESCRIPTION

Reference will now be made in detail to the embodiments, examples of which are illustrated in the accompanying drawings, wherein like reference numerals refer to the like elements throughout. The embodiments are described below to explain by referring to the figures.

The terms used in the embodiments of the present disclosure will explained briefly herein below, and then the embodiments of the present disclosure will be explained in detail.

In the embodiments of the present disclosure, words such as, “include”, “have” or the like shall be construed to designate that the characteristic, number, step, operation, element, component or a combination thereof disclosed in the present specification exist, not to exclude in advance an existence or possibility of addition one or more other characteristics, numbers, steps, operations, elements, components or a combination thereof.

Words in the singular form shall be construed to include the plural and vice versa, unless the context otherwise requires.

Further, the suffix, “unit”, are used herein in consideration of only the convenience of writing the specification, and thus does not have a distinguished meaning or role in itself.

Further, in explaining the present disclosure, any specific explanation that may obscure the gist of the present disclosure will be omitted.

Hereinafter, various embodiments of the present disclosure will be explained in detail with reference to the drawings attached.

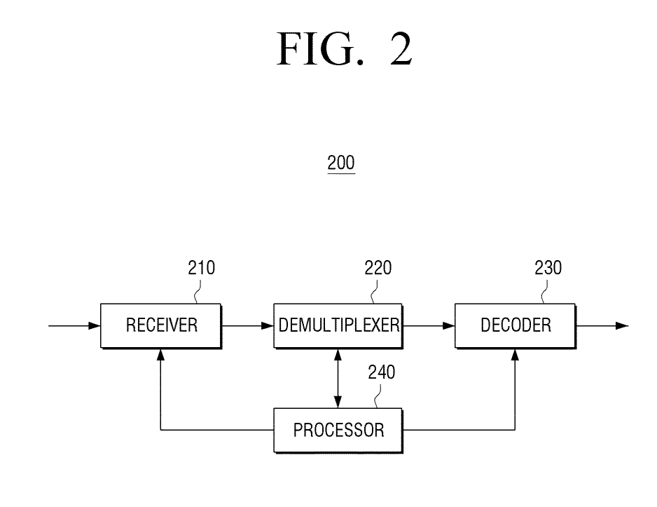

FIG. 2 is a block diagram illustrating a configuration of a broadcast receiving apparatus according to an embodiment of the present disclosure. Referring to FIG. 2, the broadcast receiving apparatus 200 includes a receiver 210, a demultiplexer 220, a decoder 230 and a processor 240. Here, the broadcast receiving apparatus 200 may be embodied as various types of electronic apparatuses such as various types of set-top boxes, TV, electronic bulletin board, electronic table, Large Format Display (LFD), smart phone, tablet, desktop PC, notebook and the like that may include processors or computers.

Here, the broadcast receiving apparatus 200 according to various embodiments of the present disclosure may operate according to the MPEG 2 system spec (ISO/IEC 13818-1). Specifically, the MPEG 2 system spec defines a Transport Stream (TS) packet structure, and the broadcast receiving apparatus according to various embodiments of the present disclosure may be any kind of apparatus that is capable of receiving a TS packet and decoding the received TS packet.

The receiver 210 receives the TS packet from an external source. Specifically, the receiver 210 may receive the TS packet from various digital broadcasting stations such as digital cable broadcasting station, digital satellite broadcasting station, digital internet broadcasting station, digital ground wave broadcasting station and the like. Here, the external source, that is, the broadcasting station may encode audio and video data in various compression methods such as MPEG 1, MPEG 2, MPEG 4 and the like, to generate a TS packet according to the MPEG 2 system spec (ISO/IEC 13818-1), and provide the generated TS packet to the broadcast receiving apparatus 200.

However, the external source is not limited to such a broadcasting station. The MPEG 2 spec that is generally applied in broadcasting and communication areas is compatible with the MPEG 1 that is generally used in digital storage media, and thus the receiver 210 may receive a TS packet from an external apparatus (for example, DVD player etc.). That is, depending on embodiments, the external source may be a player for playing various digital storage media.

The demultiplexer 220 may inversely multiplex a TS packet into a PES packet and an ES packet. Specifically, when a TS (that is, a continuous stream of TS packets) is input through the receiver 210, the demultiplexer 220 processes the TS in TS packet units into a Packetized Elementary Stream (PES) (hereinafter, PES) packet and an Elementary Stream (ES) packet.

Further, in the demultiplexing process of a TS packet, the demultiplexer 220 may extract a Program Clock Reference (PCR) (hereinafter, PCR) and a time stamp. Specifically, the demultiplxer 220 may extract a PCR from a header of the TS packet, and extract a time stamp from a header of the PES packet.

Here, the time stamp may be at least one of a Decoding Time Stamp (DTS) and a Presentation Time Stamp (PTS).

The decoder 230 may decode an ES packet. Specifically, the decoder 230 may decode an ES packet under the control of a processor 240 and generate video data and audio data.

The processor 240 controls the overall operations of the broadcast receiving apparatus 200. Especially, the processor 240 may generate a System Timing Clock (STC) based on the PCR and timestamp extracted in the demultiplexing process of the demultiplexer 220 and the buffering time during which the broadcast receiving apparatus 200 decodes the ES packet, and control the decoder to decode the ES packet based on the generated system timing clock.

Here, the buffering time during which the broadcast receiving apparatus 200 decodes the ES packet is the suitable time for the broadcast receiving apparatus 200 to process the TS being received and to decode the ES packet. The buffering time may be set appropriately by the manufacturer of the broadcast receiving apparatus 200 according to the performance of the broadcast receiving apparatus 200 or the magnitude and the like of the buffer included in the broadcast receiving apparatus 200.

Specifically, the processor 240 may compute a difference value between the PCR value and the time stamp value, compute an offset value, that is a difference between the computed difference value and the buffering time, and use the offset value to adjust the PCR value.

For example, when the difference value between the PCR value and the time stamp is greater than the buffering time, the processor 240 may add the offset value to the PCR value, and if or when the difference value between the PCR value and the time stamp value is smaller than the buffering time, the processor 240 may subtract the offset value from the PCR to adjust the PCR value.

Accordingly, the processor 240 may generate an STC according to the adjusted PCR value. Here, the processor 240 may generate an STC using an internal register included inside the processor 240, but there is no limitation thereto.

For example, in the case where or when the difference value between the PCR value extracted from the received TS packet and the PTS value is 100 ms, and the buffering time during which the broadcast receiving apparatus 200 decodes the ES packet is 70 ms, the processor 240 may generate an STC using the value of 30 ms added to the PCR value. Further, if the difference value of the PCR value and the PTS is 50 ms, the processor 240 may generate an STC using the value of the PCR value less 20 ms.

Meanwhile, the processor 240 may control the decoder 230 to decode the ES packet based on the STC generated as aforementioned. Specifically, the processor 240 may check whether or not the time corresponding to the time stamp arrived with reference to the generated STC, and control the decoder 230 to decode the ES packet according to the result of the checking.

Meanwhile, although the aforementioned embodiment was explained based on the example that the time stamp is a PTS, the same applies when the time stamp is a DTS.

In the MPEG system spec, a DTS and a PTS are defined separately, but the DTS or PTS is a value for synchronizing the MPEG system, and thus does not include absolute time information, but includes relative time information with reference to the STC generated through the PCR. Thus, it is obvious to one skilled in the related art that whether it is between the encoder and the decoder or between audio and video synchronization is possible even when decoding using any one of the DTS and the PTS.

That is, the broadcast receiving apparatus 200 may decode and display the TS using at least one of the DTS and the PTS, but the present detailed description of the embodiments is based on the assumption that only the PTS is used, for convenience of explanation.

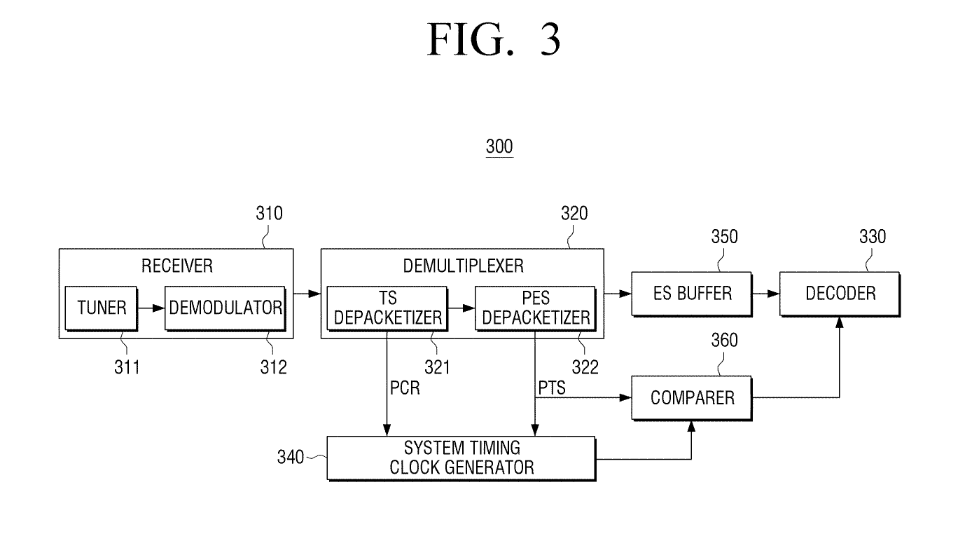

FIG. 3 is a block diagram illustrating in detail a configuration of a broadcast receiving apparatus according to another embodiment of the present disclosure. According to FIG. 3, the broadcast receiving apparatus 300 includes a receiver 310, a demultiplexer 320, a decoder 330, a system timing clock generator 340, an ES buffer 350 and a comparer 360.

The receiver 310 may receive a broadcast signal transmitted from a broadcasting station. For this purpose, the receiver 310 may include a tuner 311 and a demodulator 312. The tuner 311 provides broadcasting signals of a channel selected from a plurality of broadcast signals to the demodulator 312, and the demodulator 312 demodulates and digital-signalizes the selected broadcast signals and provides the same to the demultiplexer 320.

Here, the broadcast signals transmitted from the broadcasting station may be broadcast signals generated according to the MPEG 2 system spec (ISO/IEC 13818-1). Therefore, the demodulator 312 may provide a digital-signalized TS to the demultiplexer 320.

The demultiplexer 320 may divide the broadcast signals demodulated by the receiver 310 into various pieces of additional data defined as video data, audio data, Program and Service Information Protocol and the like, and output the same in stream form.

Specifically, the demultiplexer 320 demultiplexes the ES packets multiplexed to TS in the broadcasting station. For this purpose, the demultiplexer 320 may include a TS depacketizer 321 and a PES depacketizer 322.

The TS depacketizer 321 demultiplexes the TS being input into a PES, and provides the PES to the depacketizer 312. In this process, the PCR included in the header of the TS packet may be extracted.

The PES depacketizer 322 may demultiplex the PES being input from the TS depacketizer 321 into ES. In this process, the time stamp included in the header of the PES packet may be extracted. The ES demultiplexed as aforementioned may be buffered to the ES buffer 350 for the synchronization with the broadcasting station and the synchronization between the video data and the audio data.

Meanwhile, although it was explained with reference to FIG. 3 that the TS depacketizer 321 and the PES depacketizer 322 are additional components, there is no limitation thereto. That is, in another embodiment, one demultiplexer 320 may of course demultiplex a TS packet and a PES packet sequentially, and provided the same to the ES buffer 350.

The comparer 360 may compare the time stamp (PTS in the example of FIG. 3) and the STC (that is, the internal reference time of the broadcast receiving apparatus 300) being output from the system timing clock generator 340, and output the comparison result to the decoder 330.

That is, the comparer 360 may determine whether or not the time corresponding to the time stamp value arrived with reference to the time generated in the system timing clock generator 340, and output the determination result to the decoder 330.

The decoder 330 decodes the ES packet buffered in the ES buffer 350 and outputs the decoded video data and audio data. For this purpose, the decoder 330 may include a video decoder (not illustrated) for decoding the ES packet that includes video data, and an audio decoder (not illustrated) for decoding the ES packet that includes audio data.

Especially, the decoder 330 may decode the ES packet buffered in the ES buffer 350 with reference to the output of the comparer 360. As a result, when the time corresponding to the PTS value arrives with reference to the STC being output from the system timing clock generator 340, the decoder 330 decodes the ES packet buffered in the ES buffer 350.

Meanwhile, as aforementioned, in another embodiment, the ES packet may of course be decoded at a time when not the PTS but the DTS arrived.

The system timing clock generator 340 generates the STC that becomes the reference time by which the decoder 330 decodes the ES packet buffered in the ES buffer 350. Especially, the system timing clock generator 340 may compute the difference value between the PCR value and the time stamp value extracted in the process where the demultiplexer 320 processes the TS, and generate the STC based on the buffering time (for example, buffering time of the ES buffer 350) during which the broadcast receiving apparatus 300 decodes the ES packet.

For this purpose, the system timing clock generator 340 may include a counter circuit, but there is no limitation thereto. That is, the system timing clock generator 340 may generate the STC using an internal register included in the process as illustrated in the example of FIG. 2.

Specifically, the system timing clock generator 340 may compute the offset value, which is the difference between the difference value between the PCR value and the time stamp value and the buffering time of the ES buffer 350, and adjusting the PCR value using the computed offset value. Accordingly, the system timing clock generator 340 may generate the STC according to the adjusted PCR value.

According to an embodiment of the present disclosure, when the difference value between the PCR value and the time stamp value is greater than the buffering time of the ES buffer 350, the system timing clock generator 340 may add the computed offset value to the PCR value, and generated the STC using the PCR value to which the offset value has been added.

For example, if the difference value between the PCR value and the PTS value is 100 ms and the buffering time of the ES buffer 350 is 70 ms, the system timing clock generator 340 may generate the STC using the value of 30 ms added to the PCR value.

As aforementioned, under the MPEG 2 system spec, the difference value between the PCR value and the time stamp value becomes the buffering time required for the synchronization in the broadcast receiving apparatus 300, and thus if the required buffering time, 100 ms, is greater than the buffering time of the ES buffer 350, 70 ms, it means that the broadcast receiving apparatus 300 is capable of decoding the ES packet included in the TS in 70 ms, but it is required to wait until 100 ms to decode the ES packet.

In this case, if an STC is generated using the PCR value extracted from the TS packet as in prior art, for example, in the case of channel conversion or the like, the decoder 330 of the broadcast receiving apparatus 300 will decode after waiting until 100 ms even though it has the ability to decode the broadcast signal of the converted channel in only 70 ms, and this may result in degradation of channel conversion speed.

However, according to aforementioned embodiment of the present disclosure, since the system timing clock generator 340 adjusts the PCR value by adding 30 ms to the PCR value and generates the STC value according to the adjusted PCR value, the reference time, STC, which becomes the reference for determining whether or not the time corresponding to the PTS arrived is moved forward by 30 ms.

Therefore, the comparer 360 will determine that the time corresponding to the PTS arrived 30 ms earlier, and thus the decoder 330 will decode the ES packet 30 ms earlier than prior art, thereby increasing the speed of channel conversion.

Meanwhile, according to another embodiment of the present disclosure, when the difference value between the PCR value and the time stamp value is smaller than the buffering time of the ES buffer 350, the system timing clock generator 340 may subtract the computed offset value from the PCR value, and generate the STC using the PCR value less the offset value.

For example, if the difference value between the PCR value and the PTS value is 50 ms and the buffering time of the ES buffer 350 is 70 ms, the system timing clock generator 340 may generate the STC using 20 ms, which is the PCR value less the offset value.

As aforementioned, under the MPEG 2 system spec, the difference value between the PCR value and the time stamp value becomes the buffering time required for synchronization in the broadcast receiving apparatus 300, and thus the required buffering time, 50 ms, being smaller than the buffering time of the ES buffer 350 of the broadcast receiving apparatus 300, 70 ms, in the aforementioned example means requiring the broadcast receiving apparatus 300 that uses 70 ms to decode the ES packet included in the TS to decode the ES packet in just 50 ms.

In this case, if the STC is generated using the PCR value as it is extracted from the TS packet as in prior art, an error such as underflow or the like may occur, which may appear as video and audio data being disconnected while being played.

However, according to the aforementioned embodiment of the present disclosure, the system timing clock generator 340 may adjust the PCR value by subtracting 20 ms from the PCR value, and generate an STC according to the adjusted PCR value, and thus the STC, which is the reference time for determining whether or not the time corresponding to the PTS arrived will be postponed by 20 ms.

Therefore, the comparer 360 determines that the time corresponding to the PTS arrived 20 ms later, and thus the decoder 330 will decode the ES packet 20 ms later than it would have in prior art. That is, the STC is adjusted to the buffering time of the ES buffer 350 that the broadcast receiving apparatus 300 uses, 70 ms, and thus an erroneous operation such as underflow or the like will not occur.

Meanwhile, the configuration of the broadcast receiving apparatus 300 is not limited to that illustrated in FIG. 3. Depending on embodiments, some of the elements illustrated in FIG. 3 may be omitted or modified, or other elements may be added.

Although not illustrated in the drawings, examples of such other elements that the receiving apparatus 300 may further include are: a video processor, an audio processor, a speaker and a display.

In this case, the audio processor may signal-process the audio data decoded in the aforementioned decoder (not illustrated) to be suitable to the output standard of the speaker and output the same. Further, the video processor may signal-process the video data decoded in the aforementioned video decoder (not illustrated) to have the vertical frequency, resolution, screen ratio and the like suitable to the output standard of the display, and output the same. Further, the speaker and the display may output the audio data and the video data being output from the audio processor and the video processor as sound and images.

Meanwhile, the operations of the demultiplexer 320, the ES buffer 350, the system timing clock generator 340 and the comparer 360 illustrated in FIG. 3 being embodied in software modules, and the processor executing each module to perform the aforementioned configurations may be an example where some of the elements are omitted or modified.

Further, according to an embodiment of the present disclosure, at least two of the configurations illustrated in FIG. 3 may be embodied in a System On Chip (SOC) form. For example, the demultiplexer 320, the ES buffer 350, the system timing clock generator 340 and the comparer 360 may be embodied in one SOC, but there is no limitation thereto.

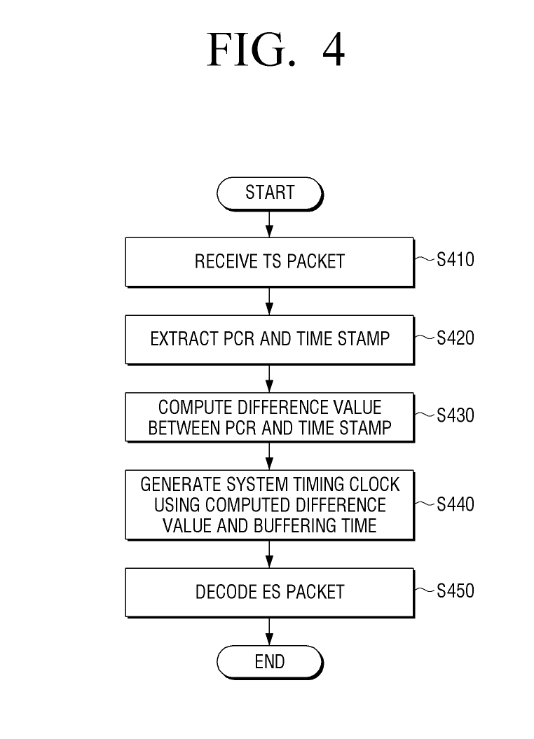

FIG. 4 is a flowchart illustrating a controlling method of a broadcast receiving apparatus according to an embodiment of the present disclosure and the method may be performed by a processor, such as a computer and a memory. Here, according to an embodiment of the present disclosure, the broadcast receiving apparatus may be a broadcast receiving apparatus that conforms to the MPEG 2 system spec (ISO/IEC 13818-1.)

The MPEG 2 system spec (ISO/IEC 13818-1) defines only the TS structure, and not the method of coding video and audio data, and thus the method of coding video and audio data is not limited to the broadcast receiving apparatus to which the various embodiments of the present disclosure apply.

Referring to FIG. 4, the broadcast receiving apparatus receives a TS packet (S410), and extracts a PCR and a time stamp from the received TS packet (S420). Here, the time stamp may be at least one of a DTS and a PTS.

Accordingly, the broadcast receiving apparatus computes a difference value between the extracted PCR value and the time stamp value (S430), and generates an STC based on the computed difference value and the buffering time during which the broadcast receiving apparatus decodes the ES packet included in the TS packet (S440).

Under the MPEG system, the broadcast receiving apparatus decodes or displays the ES packet at a time corresponding to the time stamp, and the STC becomes the reference time for determining whether or not the time corresponding to the time stamp arrived. Therefore, the broadcast receiving apparatus decodes the ES packet based on the generated system timing clock (S450).

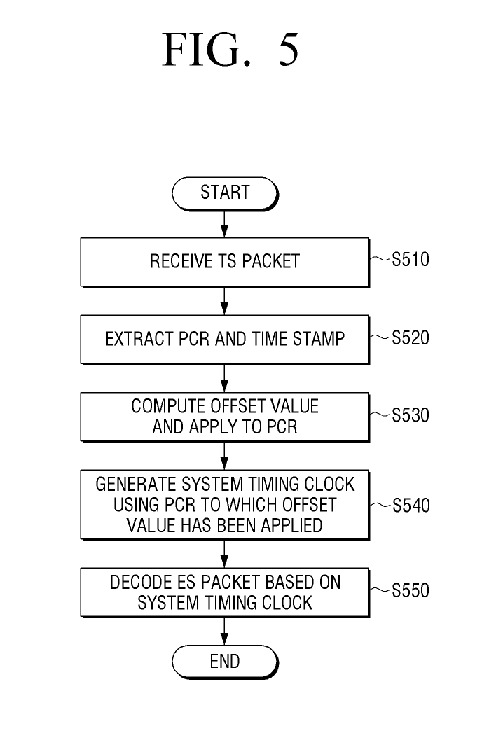

FIG. 5 is a flowchart illustrating a controlling method of a broadcast receiving apparatus according to another embodiment of the present disclosure and may be performed by a processor, such as a computer, and a memory. According to FIG. 5, the broadcast receiving apparatus receives a TS packet (S510), and extracts a PCR and a time stamp from the received TS packet (S520).

Accordingly, the broadcast receiving apparatus computes an offset value that is a difference between the buffering time (that is, difference value between the PCR value and the time stamp value) that the encoder side (for example, broadcasting station) requires to the broadcast receiving apparatus according to the MPEG 2 system spec and the buffering time that the broadcast receiving apparatus actually uses in decoding the ES packet, and applies the computed offset value to the PCR (S530).

Here, an example of a math formula 1 for computing the offset value is shown below. But of course there is no limitation thereto.

Offset value=|buffering time of broadcast receiving apparatus−|PCR value-time stamp value∥ [Math formula 1]

Specifically, if or when the buffering time requested by the encoder side is greater than the suitable buffering time that the broadcast receiving apparatus uses, the broadcast receiving apparatus may add the offset value to the PCR value, and if or when the buffering time requested by the encoder side is smaller than the suitable buffering time that the broadcast receiving apparatus uses, the broadcast receiving apparatus may subtract the offset value from the PCR value.

Accordingly, the broadcast receiving apparatus generates the STC using the PCR applied to the offset value (S540), and decodes the ES packet based on the generated STC (S550). Specifically, the broadcast receiving apparatus may check whether or not the time corresponding to the time stamp value arrived with reference to the generated STC, and decode the ES packet according to the checking results.

As aforementioned, although a DTS and a PTS are defined separately in the MPEG system spec, synchronization is possible between the encoder and the decoder and between audio and video even when only one of the DTS and PTS is used, for example, in the case where the broadcast receiving apparatus uses a PTS only, as mentioned above, the broadcast receiving apparatus may decode the ES packet when the time corresponding to the PTS arrived with reference to the generated STC.

However, there is no limitation thereto, and thus in the case of a broadcast receiving apparatus that uses only a DTS, the broadcast receiving apparatus may of course decode the ES packet when the time corresponding to the DTS arrived with reference to the generated STC.

According to the various embodiments of the present disclosure, it is possible to solve the problem of erroneous operation and degradation of channel conversion speed, caused by the buffering time required in the broadcast receiving apparatus according to the difference between the PCR and the time stamp being different from the actual buffering time used by the broadcast receiving apparatus to process a TS stream.

Specifically, according to the aforementioned various embodiments of the present disclosure, AV (Audio and Video) replay errors caused by erroneous operations such as underflow and the like when the difference between the PCR and the PTS is smaller than the buffering time of the broadcast receiving apparatus is improved.

Further, it is possible to replay AV regarding a scenario of starting a broadcasting such as channel conversion and the like when the difference between the PCR and the PTS is greater than the buffering time of the broadcast receiving apparatus faster than it would have in prior art. Further, in this case, the buffering size required in the broadcast receiving apparatus may be reduced when replaying AV in a conventional method, thereby reducing the average amount of buffering used.

Meanwhile, the operations of the processor 240 of the broadcast receiving apparatus 200 and controlling methods of the broadcast receiving apparatus 200 according to the aforementioned various embodiments may be embodied as software and mounted on a broadcast receiving apparatus.

For example, a non-transitory computer readable recording medium for storing a program to perform the method of controlling a broadcast receiving apparatus may be installed, the program including a step of receiving a TS packet from an external source, a step of extracting a PCR and a time stamp from the TS packet; a step of computing a difference value between the PCR value and the time stamp value; a step of generating a system timing clock based on the computed difference value and a buffering time during which the broadcast receiving apparatus decodes an ES packet included in the TS packet; and a step of decoding the ES packet based on the generated system timing clock.

Here, the non-transitory computer readable recording medium refers to not a medium that stores data for a short period of time such as a register, cache, memory and the like, but a medium readable by a device and that stores data semi-permanently. Specifically, the aforementioned various middleware or programs may be stored in and provided through a non-transitory computer readable medium such as CD, DVD, hard disk, blue ray disk, USB, memory card, ROM and the like, and be provided.

The foregoing exemplary embodiments and advantages are merely exemplary and are not to be construed as limiting. The present teaching can be readily applied to other types of apparatuses. Also, the description of the exemplary embodiments of is intended to be illustrative, and not to limit the scope of the claims, and many alternatives, modifications, and variations will be apparent to those skilled in the art.

Although a few embodiments have been shown and described, it would be appreciated by those skilled in the art that changes may be made in these embodiments without departing from the principles and spirit thereof, the scope of which is defined in the claims and their equivalents.

What is claimed is:

1. A method of controlling a broadcast receiving apparatus, the method comprising:
receiving a Transport Stream (TS) packet from an external source;
extracting a Program Clock Reference (PCR) and a time stamp from the TS packet;
computing a difference value between the PCR value and the time stamp;
generating a system timing clock based on the difference value and a buffering time during which the broadcast receiving apparatus decodes an Elementary Stream (ES) packet included in the TS packet; and
decoding the ES packet based on the system timing clock.

2. The method according to claim 1,
wherein the generating the system timing clock comprises:
computing an offset value that is an offset difference between the difference value and the buffering time;
adjusting the PCR value using the offset value; and
generating the system timing clock according to an adjusted PCR value.

3. The method according to claim 2,
wherein the adjusting the PCR value adds the offset value to the PCR value when the difference value is greater than the buffering time.

4. The method according to claim 2,
wherein the adjusting the PCR subtracts the offset value from the PCR value when the difference value is smaller than the buffering time.

5. The method according to claim 1,
wherein the decoding comprises:
checking whether a time corresponding to the time stamp arrived with reference to the system timing clock; and
decoding the ES packet according to results of the checking.

6. The method according to claim 1,
wherein the broadcast receiving apparatus conforms to the MPEG 2 system spec (ISO/IEC 13818-1).

7. The method according to claim 1,
wherein the time stamp is at least one of a decoding time stamp (DTS) and a presentation time stamp (PTS).

8. A broadcast receiving apparatus, comprising:
a receiver that receives a Transport Stream (TS) packet from an external source;
a demultiplexer that demultiplexes the TS packet into a Packetized Elementary Stream (PES packet) and an Elementary Stream (ES) packet;
a decoder that decodes the ES packet; and
a processor that uses a Program Clock Reference (PCR) and a time stamp being extracted during demultiplexing of the demultiplexer to compute a difference value between the PCR value and the time stamp, that generates a system timing clock based on a buffering time during which the broadcast receiving apparatus decodes the ES packet, and that controls the decoder to decode the ES packet based on the system timing clock.

9. The apparatus according to claim 8,
wherein the processor computes an offset value that is an offset difference between the difference value and the buffering time, adjusts the PCR value using the offset value, and generates the system timing clock according to an adjusted PCR value.

10. The apparatus according to claim 9,
wherein the processor adds the offset value to the PCR value when the difference value is greater than the buffering time.

11. The apparatus according to claim 9,
wherein the processor subtracts the offset value from the PCR value when the difference value is smaller than the buffering time.

12. The apparatus according to claim 8,
wherein the processor checks whether a time corresponding to the time stamp arrived with reference to the system timing clock, and controls the decoder to decode the ES packet according to results of the checks.

13. The apparatus according to claim 8,
wherein the broadcast receiving apparatus conforms to the MPEG 2 system spec (ISO/IEC 13818-1).

14. The apparatus according to claim 8,
wherein the time stamp is at least one of a decoding time stamp (DTS) and a presentation time stamp (PTS).

15. A non-transitory computer readable recording medium including a program for executing a controlling method of a broadcast receiving apparatus, the controlling method comprising:
receiving a Transport Stream (TS) packet from an external source;
extracting a Program Clock Reference (PCR) and a time stamp from the TS packet;
computing a difference value between the PCR value and the time stamp;
generating a system timing clock based on the difference value and a buffering time during which the broadcast receiving apparatus decodes an Elementary Stream (ES) packet included in the TS packet; and
decoding the ES packet based on the system timing clock.
